(19) United States
(12) Patent Application Publication
(10) Pub. No.: US 2005/0027500 A1
(43) Pub. Date: Feb. 3, 2005

(54) Real-time software scheduler for personal computers

(76) Inventors: Dennis Thomas Cornhill, St. Paul, MN (US); Naveen VenkateshPrasad Nama, Bangalore (IN)

Correspondence Address: HONEYWELL INTERNATIONAL INC., 101 COLUMBIA ROAD, P O BOX 2245, MORRISTOWN, NJ, 07962-2245, US

(21) Appl. No.: 10/903,838

(22) Filed: Jul. 30, 2004

Related U.S. Application Data
(60) Provisional application No. 60/492,012, filed on Aug. 1, 2003.

(51) Int. Cl. G06F 17/50

(52) U.S. Cl. 703/13

(57) ABSTRACT

A method for operating a real time simulation on a non real time computer platform is disclosed. In the method, a simulated time counter is initialized at a first simulated time step. Then, all processor threads that must complete execution during a current simulated time period are run. The simulated time counter is increment by a next simulated time step and the process starts again. The method may also include a wall time counter that is initiated at the same time the simulated time counter is initiated. The wall time counter increments at a set interval. The wall time counter is checked against the simulated time counter after all current processor threads are run. If the wall time counter is greater than the simulated time counter, the simulated time counter is incremented by one time period. If the wall time counter is not greater than the simulated time counter, a future processor thread is executed.

### CROSS REFERENCE TO RELATED APPLICATIONS

This application claims the benefit of U.S. Provisional Application No. 60/492,012, filed Aug. 1, 2003.

### TECHNICAL FIELD

The present invention generally relates to simulation software, and, more particularly, to a simulated real time software scheduler for personal computers.

### BACKGROUND

Dedicated real time simulators are simulators that are specifically designed to function as a high fidelity simulator for a system. Dedicated real time simulators achieve high fidelity by reusing the real time hardware and software of the system being simulated. Dedicated real time simulators are used for training purposes in many different fields of endeavor such as avionics. Real time simulators allow trainees to learn how to operate a complex system without fear of personal injury or system damage. In addition, dedicated real time simulators can be used to test new software.

Dedicated real time simulators, while useful in many ways, suffer from several drawbacks. First, dedicated real time simulators are very expensive. One factor in the expense of real time simulators is the cost of designing, building and maintaining the real time computing platforms that run the simulation software for the simulator. These real time computing platforms provide a controllable process that enables scheduling of each task to be performed in real time by the computing platform. Because real time simulators are costly, access to the real time simulators tends to be limited.

Therefore, it is desirable to provide a lower cost and more accessible way to provide real time simulations of systems. One solution is to provide a slightly lower fidelity simulation that reuses the real time software of the system being simulated, but not the real time hardware. This greatly lowers cost, not just by eliminating costly real time hardware, but also by enabling the use of commercially available personal computers to run real time simulation software. While a significant cost savings can be realized by using commercially available personal computers, the operating systems of personal computers do not allow for controllable process timing. This is due, in part, to the fact that personal computer operating systems unpredictably interrupt application processing for various housekeeping functions.

Because of these unpredictable system interruptions when using personal computers it is impossible to guarantee that processes that run the simulation will execute within the required time periods expected by the real time software. Thus, delays can occur that can either prevent the correct execution of the real time software or cause timing variations (execution that is too fast or too slow) that are perceived by the human user and consequently compromise the value of the simulation tool. Therefore, what is needed is a real time software scheduler for personal computers that allows the real time software to execute correctly, and at a rate that appears correct to a human observer who is knowledgeable in the system being simulated.

### BRIEF SUMMARY

In one embodiment of the present invention, a method for operating a real time simulation on a non real time computer platform is disclosed. In the method, a simulated time counter is initialized at a first simulated time step. Then, all threads that must complete execution during a current simulated time period are run. The simulated time counter is increment by a next simulated time step and the process starts again.

In another embodiment of the present invention, a wall time counter is initiated at the same time the simulated time counter is initiated. The wall time counter increments at a set interval. The wall time counter is checked against the simulated time counter after all current processor threads are run. If the wall time counter is greater than the simulated time counter, the simulated time clock is incremented by one time period. If the wall time counter is not greater than the simulated time counter, a future thread is executed.

### BRIEF DESCRIPTION OF THE DRAWINGS

The present invention will hereinafter be described in conjunction with the following drawing figures, wherein like numerals denote like elements, and

FIG. 1 is a block diagram of an exemplary apparatus for running real-time software on a non real-time platform in accordance with the present invention;

FIG. 2 is a flowchart of an exemplary method of scheduling real-time software tasks on a non real-time platform;

FIG. 3 is a flowchart of another exemplary method of scheduling real-time software tasks on a non real-time platform; and

FIG. 4 is a flowchart of yet another exemplary method of scheduling real-time software tasks on a non real-time platform.

### DETAILED DESCRIPTION

The following detailed description is merely exemplary in nature and is not intended to limit the invention or the application and uses of the invention. For example, while one use of the present invention is in real time avionics simulation, the present invention can be used in any other simulators or programs when the monitoring of time reference is needed. Furthermore, there is no intention to be bound by any expressed or implied theory presented in the preceding technical field, background, brief summary or the following detailed description.

The present invention provides a scheduler for the execution of real time software on personal computers. Real time in the present invention can be actual real time when events occur within the simulations at the same time they would occur outside the simulation. Real time in the present invention can also mean near real time where the user is unable to perceive a substantial difference between the occurrence of events within the simulation and occurrence of events outside the simulation.

The present invention considers time as perceived by a human observer (known as wall time), time as viewed by the real time software (known as simulated time) and the management of simulated time to constrain simulated time to wall time. The invention, in one embodiment of the present invention, simulated time does not advance at a rate faster than wall time. Additionally, in another embodiment, any harm that may occur when simulated time advances more slowly than wall time (which can occur when the PC interrupts the simulation to perform unrelated activities) is managed.

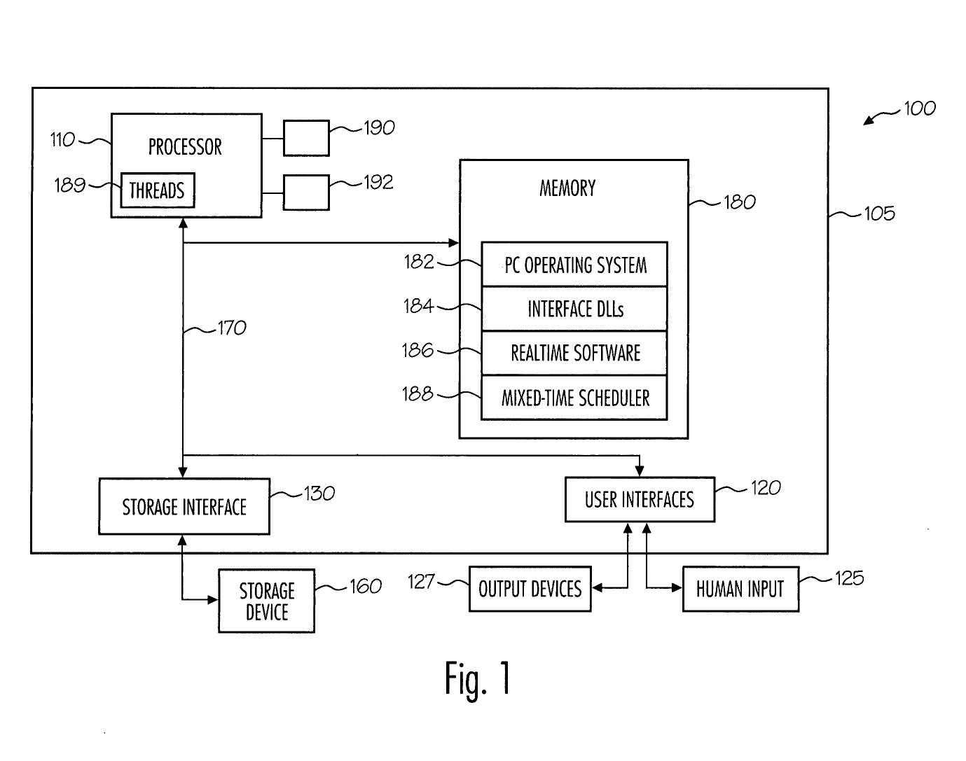

FIG. 1 illustrates an exemplary apparatus 100 for executing real time software 186 on a computing platform 105. The computing platform 105 comprises a processor 110 coupled to a memory 180, a storage interface 130 and a user interface 120 by a bus 170. The computing platform 105 can be any computer device having a processor and a memory and capable of executing software under the control of an operating system. For example, a personal computer can be a computer utilizing the WINDOWS operating system, the Macintosh OS, LINUX, UNIX and the like. Computing platform 105 can be all or part of a desktop computer, a laptop computer, a personal digital handheld computer and the like.

Processor 110 can be any commercially available processor used in personal computers such as those manufactured by Intel Corp. of Santa Clara, Calif., or Advanced Micro Devices of Sunnyvale, Calif. While the processor 110 is illustrated in FIG. 1 as a single functional block, it is known in the art that the processor can include any number of individual microprocessor, memories, storage devices, interfaces and other components. One or more clocks or counters can be coupled to processor 110. For example, a simulated time clock 190 either alone or with a wall time clock 192 can be coupled to processor 110. The use of simulated time clock 190 and wall time clock 192 are discussed in detail below.

The memory 180 comprises one or more memory and/or storage devices, however coupled. For example, memory 180 can include read only memory (ROM), random access memory (RAM), flash memory and the like. Memory 180 is configured to store an operating system 182, an interface 184, a real time simulation software 186 and a mixed time scheduler 188. The operating system 182 can be any conventional operating system such as the WINDOWS operating system. The interface 184 provides an interface between the real time software 186 and the operating system 182. The interface 184, in one embodiment, can be part of a series of dynamic link library programs as utilized by the WINDOWS operating system, to, among other things, assist programs in accessing resources on the computing platform 105.

Real time software 186 can be any software program in which activities in the program appear to a user to occur at the same rate as the actual system. Therefore, a certain tolerance can exist between the simulated time and the perceived time. The tolerance can be determined based upon the application. For example, for a flight simulator, a tolerance of 100 milliseconds may be selected because human perception does not usually discriminate time periods smaller than 100 milliseconds.

When real time simulation software 186 executes, a plurality of program threads 189 are started. A thread is a single sequential flow of control within a program. Typically, multiple threads appear to be running simultaneously, each thread performing a certain task. Typically, threads are periodic. That is, they repeatedly perform the same activity, once each period. The periodicity of threads varies depending upon the function of the thread. Threads execute within the framework of the real time software 186 system ticks. For example, in one embodiment, each system tick can be 12.5 seconds long, and thread periods vary from one (1) to eighty (80) system ticks.

In order for the real time simulation software 186 to appear to be operating in real time as perceived by a user, the timing relationship between and within the various threads must be maintained. The coordination of the timing of the threads is, in one embodiment, accomplished by the time scheduler 188. Time scheduler 188 may be integrated with simulations software such as with the real time software 186 or can operate as a separate program sharing data with other programs such as the real time software 186.

Storage interface 130 provides the processor 110 with access to a storage devices 160, which may be any number of discrete data storage devices 160. Data storage device 160 stores data and program files for use by the processor 110 or any other component of computing platform 105. Storage devices 160 can be, for example, a hard disk drive, a floppy disk drive, a readable, writable optical device, solid-state storage devices and the like. In one embodiment of the present invention, storage devices 160 can store a computer program product comprising a computer useable medium having a computer readable code means embodied in said medium for operating real-time simulation software in a non real-time environment.

User interface 120 includes interfaces for user inputs from input devices 125, such as by keyboard, joystick mouse and the like. User interface 120 also provides interfaces for outputs to users on output devices 127 such as a display and/or audible outputs (not illustrated). It will be appreciated that all or some of the processor 110, memory 180, bus 170, interfaces 120 and 130, storage device 160, and display may be those normally supplied with a PC.

While FIG. 1 illustrates the present invention in a single computing platform 105 such as a stand-alone PC, the computing platform 105 may be connected to other computer platforms as part of a computer network. In this embodiment, real time simulation program 186 can be accessed by geographically dispersed but connected users. For example, users of personal computers connected over a network such as the Internet could access the simulation program 186 running a remote server. In addition, the computing platform 105 can be integrated with continuous component devices, such as a motion feedback system to form physical motion simulation for training pilots.

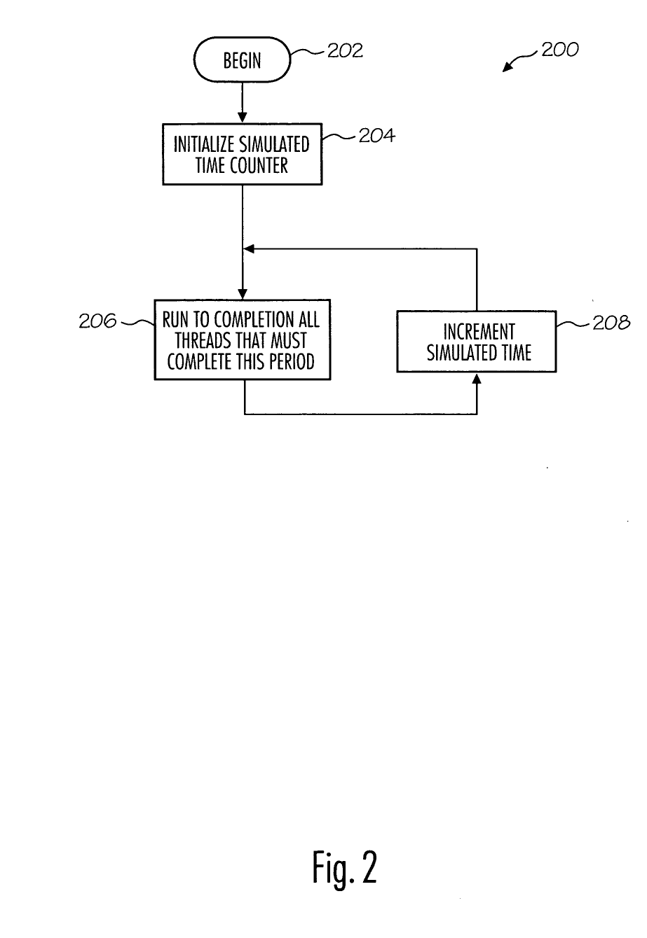

In order to provide a user with the perception of operating in real time, the various processes involved must be scheduled and executed in such a way as to provide the perception of real time execution to the user. In one embodiment of the present invention, this can be accomplished by thread scheduling using, in one embodiment, the time scheduler 188. FIG. 2 shows a flowchart of an exemplary method 200 for thread scheduling. The method 200 begins at step 202 with the beginning of a simulation. Next, a simulated clock or counter is initiated in step 204. In one embodiment, the simulated clock is incremented in terms of a simulated time step. In a particular embodiment, the simulated time step simulates the time step used in dedicated real time simulators. For example, a simulated time step of 12.5 milliseconds (80 Hz) can be used. In one embodiment, the clock initiated in step 204 can be a counter controlled by the processor 110 as shown in FIG. 1.

As discussed previously, different threads vary in the length of time it takes to execute. Each thread has a period, wherein the period is an integer multiple of the simulated time step. For example, there can be a one time step period thread, which requires a single time step to run, a four time step period thread which requires four time steps to run or a n-time step thread, where n is an integer multiple. The periodic threads become ready to run at the beginning of their period and must complete by the end of their period. Only threads in the ready state may run; thus, completed threads cannot run again until they become ready at the start of their next period. Threads that are ready and in the last time step of their period must be completed in the current time step; they can be referred to as current threads. Threads that are ready but do not need to complete until a later time step can be referred to as future threads. While current threads must complete during the current time step period, future threads may complete during any time step before the end of their period. Once a thread is completed in a time step, the thread is set to a completed status. Since threads are periodic, completed threads return to the ready status at the beginning of their next period.

As an example, consider a first thread having a periodicity of one time step, a second thread having a periodicity of five time steps, a third thread having a periodicity of ten time steps and a fourth thread having a periodicity of twenty time steps. At time step 1, all threads become ready to run. By the completion of time step twenty (20), all threads have completed at least once and the schedule repeats. The time to complete the entire schedule once (20 time steps in this example) is known as a hyperperiod. Table 1 illustrates the threads and the thread status for each time step of an exemplary hyperperiod.

| | Thread 1 | | | Thread 2 | | | Thread 3 | | | Thread 4 | | |
|---|---|---|---|---|---|---|---|---|---|---|---|---|
| Time Step | Ready | Current | Future | Ready | Current | Future | Ready | Current | Future | Ready | Current | Future |
| 1 | X | X | | X | | X | X | | X | X | | X |
| 2 | X | X | | | | X | | | X | | | X |
| 3 | X | X | | | | X | | | X | | | X |
| 4 | X | X | | | | X | | | X | | | X |
| 5 | X | X | | | X | | | | X | | | X |
| 6 | X | X | | X | | X | | | X | | | X |
| 7 | X | X | | | | X | | | X | | | X |
| 8 | X | X | | | | X | | | X | | | X |
| 9 | X | X | | | | X | | | X | | | X |
| 10 | X | X | | | X | | | X | | | | X |
| 11 | X | X | | X | | X | X | | X | | | X |
| 12 | X | X | | | | X | | | X | | | X |
| 13 | X | X | | | | X | | | X | | | X |
| 14 | X | X | | | | X | | | X | | | X |
| 15 | X | X | | | X | | | | X | | | X |
| 16 | X | X | | X | | X | | | X | | | X |
| 17 | X | X | | | | X | | | X | | | X |
| 18 | X | X | | | | X | | | X | | | X |
| 19 | X | X | | | | X | | | X | | | X |
| 20 | X | X | | | X | | | X | | | X | |

Note that a thread can be completed at any time within its period. Table 1 shows when the threads become ready to run (Ready column) and their deadline for completion (Current column). Table 1 does not show when the threads actually complete, which in general is not known until the simulation runs. If a future thread does complete early, that is, before it becomes a current thread, then that thread does not become ready to run again until the beginning of its next period.

With this in mind, a time step starts in step 204. Within each time step, threads that are ready to be completed and need to be completed during the current step (the current threads) are run to completion regardless of the amount of “real” time required to do so (step 206). The number of current threads that need to be executed in a single step can vary. However, no matter how many current threads need to be completed in a time step and no matter how many interruptions occur because of the activities of the operating system in that time step, all current threads continue to completion.

When all current threads are complete in step 208 the simulated clock (or counter) is incremented by a simulated time step and the next time step begins at step 206. In this embodiment, while the amount of time required to execute a simulated time step may vary with respect to a fixed time reference, all threads, when measured to the granularity of their period, progress in simulated time, as they would in the actual system in real time.

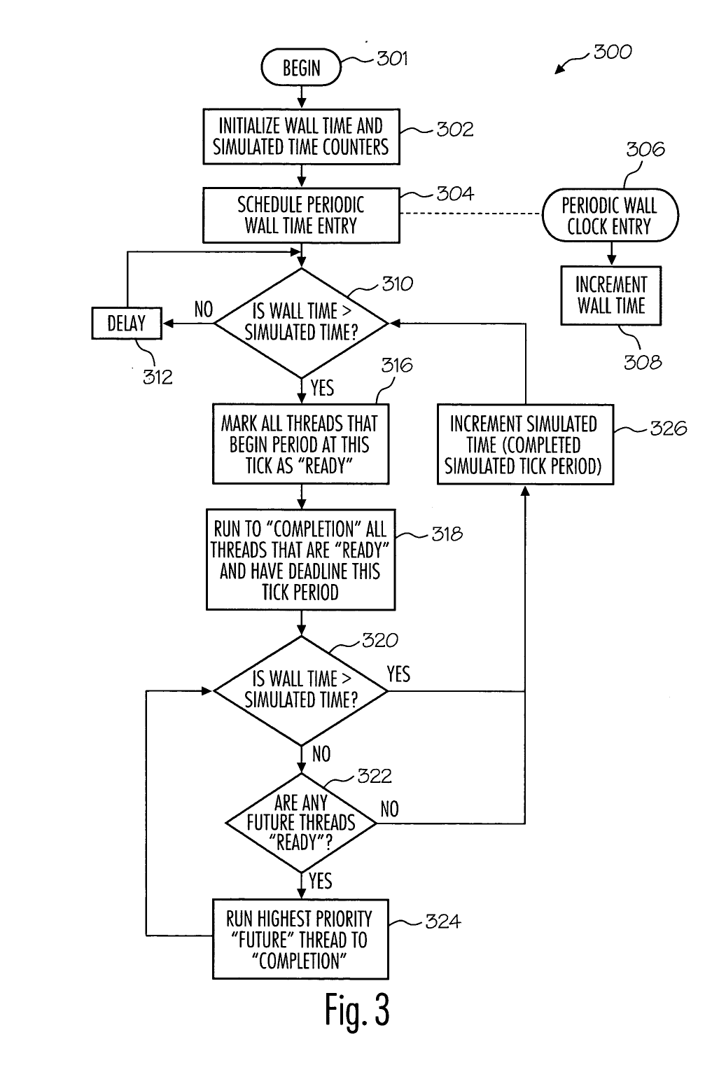

In another embodiment, the thread scheduling is also done to ensure that the simulation does not appear to a user as running faster than what would occur in real time. FIG. 3 illustrates a method for scheduling threads that prevents simulated time from running faster than real time. In this embodiment, both a simulated time clock (or counter) and a wall time clock (or counter) are tracked.

In the method as shown, in FIG. 3, a wall time clock and a simulated time clock are initiated in step 302. In step 304, a time period is set for the wall time clock. In one embodiment, the time period is set to 12.5 msec, a typical time period for dedicated real time systems. However, any useful time period can be chosen. The wall time clock increments every time period as shown in step 308. The advancement of the wall time clock occurs at every time period.

In step 310, it is determined if the wall clock time (or in the embodiment where the clock is a counter, the wall counter count) is greater than the simulated clock time (or simulated counter count). If the wall clock time is not in advance of the simulated clock time, a delay is initiated that lasts until the wall clock time increments by another time period (step 312). After the delay in step 312, it is again determined if wall clock time is greater than simulated clock time.

If the wall clock time leads the simulated clock time, in step 316, all threads that are beginning a period in the current simulated time step are marked ready. In step 318, all threads that are identified as ready in step 316 and must be executed in this time period (the current threads) are run to completion. All current threads are run to completion in step 318 regardless of the actual wall clock time it takes to execute the complete threads. This was also discussed in conjunction with the embodiment of FIG. 2.

In the embodiment of FIG. 3, after all current threads are executed it is determined if wall clock time is greater than the simulated clock time (step 320). If wall clock time is not greater than simulated clock time, then additional threads can be run. Specifically, in one embodiment, in step 322, it is determined if there are any unexecuted threads that are ready to run (future threads). If there are any future threads, the highest priority future thread is executed to completion (step 324). Priority, in one embodiment is based on when the thread will reach its deadline. For example, in one embodiment of the present invention, a thread that has to execute by the next time period is considered to have higher priority than a thread that needs to be executed four time periods in the future. After a future thread is executed in step 324, a check again is made to see if wall clock time is greater than simulated clock time (step 320). If wall clock time is still not greater than simulated clock time, the next highest priority future thread is executed. Future threads are executed either until there are no more future threads (step 324) or until wall clock time advances ahead of simulated clock time (in step 320).

If, in step 320, it is determined that wall clock time leads simulated clock time, the simulated clock time is advanced one time period, in step 326. In addition, if, in step 322, it is determined there are no more ready threads in the current time step, the simulated clock time advances a time period in step 326. After the simulated time clock is advanced in step 326, step 310 is executed, repeating the method of FIG. 3.

Because it is undesirable for the simulation to appear to execute too quickly the simulated time clock or counter, in one embodiment of the present invention, is never allowed to exceed the wall time clock or counter (that is, simulated time does not run ahead of wall time). Therefore, a human observer will not see a simulation that completes more work since startup than the real system would be able to complete in the equivalent amount of time since startup.

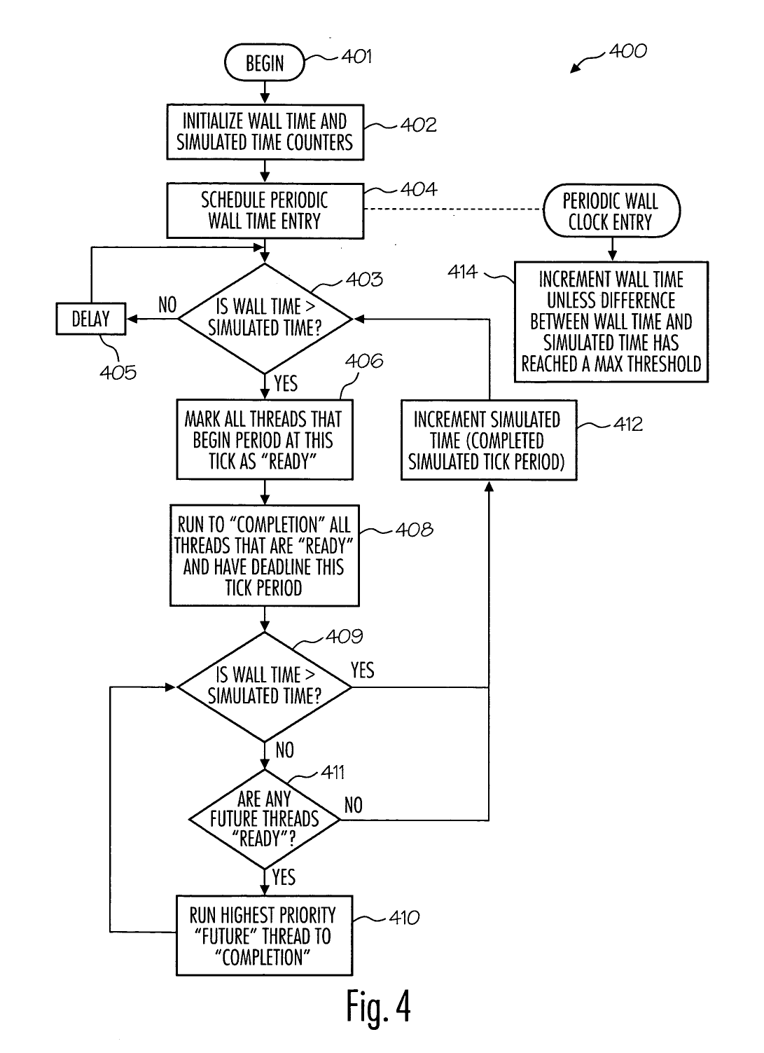

While the second embodiment limits the overall progress of the simulation to that of the real system, a simulation that had fallen behind might be allowed to catch up suddenly, and in a way that is apparent to a human observer. An embodiment of the present invention that addresses this issue is seen in FIG. 4. When simulated time falls behind wall time by a small enough amount to not be discernable to a human observer, the simulation is allowed to “catch up”, if it can, by running simulated ticks as quickly as possible.

If simulated time falls behind wall time by more than a human discernable amount of time, the simulation is not allowed to recover the time because the human observer would likely notice both the slow down that has already occurred and the speed up in response. The slow down is due to inadequate computing resources; it is undesirable and unavoidable. The speed up is also undesirable but can be avoided by not attempting to recover the lost time. FIG. 4 is a flowchart illustrating an embodiment that keeps simulated clock time from lagging the wall clock time by more than a threshold amount.

FIG. 4 is similar to FIG. 3 in several respects. Like FIG. 3, two clocks, a simulated time clock and a wall time clock are initiated (step 402). The time period of the wall time clock is set in step 404. If the wall clock time leads the simulated clock time then all ready threads are identified (step 406) and all ready threads that must be execute in the current time step are executed (step 408). If, after executing all of the current threads, the wall clock time does not lead the simulated clock time and there are ready future threads, those future threads are executed one at a time (step 410). Once the wall clock time exceeds the simulated clock time, the simulated clock is incremented (step 412) and the process begins again. In addition, if there are no more ready threads, the simulated clock is incremented (step 412) and the process begins again.

As discussed before, the wall clock increments according to the period specified in step 404. In this embodiment, the wall clock is incremented according to schedule unless the wall clock time exceeds the simulated clock time by a threshold value (step 414). The threshold value can be any value. In one embodiment, the threshold value is set to the level of human perception for the particular simulation. That is, there exists a time delay that above which a typical user would perceive. For example, in an aircraft simulation environment, a typical user would begin to perceive when the difference between the wall clock time and the simulation clock time exceed 100 milliseconds. Therefore, the threshold would be set to 100 milliseconds. If the wall clock time exceeds the simulated clock time by the threshold, the wall clock could be suspended until the difference between the wall clock and the simulated clock was less than the threshold. Alternatively, the wall clock could be adjusted backwards. Any other methods of maintaining the wall clock and the simulated clock within a threshold value of each other can be used.

Therefore, in this embodiment, the simulation time is kept from lagging the wall time by more than a threshold amount. As shown in FIG. 4, this embodiment is done in conjunction with the embodiment of FIG. 3, which helps to prevent the simulation time from exceeding the wall clock time. It is possible, however, to provide for keeping the simulation time from lagging the wall time without the steps needed to keep the simulation time from exceeding the wall time. This can be done, for example, in situation where it is known the simulation time is unlikely to exceed the wall time but could fall behind the wall time by more than a threshold. For example, if there were numerous one period threads that needed to be run each time step, the chances of the simulation time getting ahead of the wall time may be remote.

While exemplary embodiments have been presented in the foregoing detailed description, it should be appreciated that a vast number of variations exist. It should also be appreciated that the exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A method for operating a real time simulation on a non real time computer platform comprising:
a) initializing a simulated time counter at a first simulated time step;
b) running all current processor threads;
c) incrementing the simulated time counter by a next simulated time step; and
d) repeating steps b-d.

2. The method of claim 1 further comprising:
initiating a wall time counter at same time the simulated time counter is initiated, the wall time counter incrementing at a set interval;
checking the wall time counter against the simulated time counter after all current processor threads are run;
if the wall time counter is greater than the simulated time counter, incrementing the simulated time counter by one time period; and
if the wall time counter is not greater than the simulated time counter, executing a future processor thread.

3. The method of claim 2 further comprising:
after executing a future processor thread, comparing the wall time counter against the simulated time counter;
executing another future processor thread if the wall time counter is not greater than the simulated time counter;
incrementing the simulated time counter if the wall time counter exceeds the simulated time counter; and
executing all processor threads that must complete during a new simulated time period.

4. The method of claim 3 wherein the step of comparing the wall time counter against the simulated time counter further comprises maintaining the wall time counter within a threshold value of the simulated time counter.

5. The method of claim 4 wherein the step of maintaining the wall time counter within a threshold value of the simulated time counter further comprises suspending the incrementing of the wall time counter when the wall time counter and the simulated time counter differ by more that the threshold.

6. The method of claim 4 further comprising the step of setting the threshold based on the minimum time that a user would perceive as a delay.

7. The method of claim 2 further comprising the step of executing a future processor thread that needs to be completed in a future time step closest to the current time step.

8. A system for running a real-time simulations on non-real time components comprising:
a simulated time counter configured to track simulated time steps and
a processor coupled to the simulated time counter the processor operable to:
a) run all current processor threads;
b) increment the simulated time counter by a next simulated time step; and
d) repeating steps b-d.

9. The system of claim 8 further comprising a wall time counter coupled to the processor and configured to track the passage of wall time, the wall time counter incrementing at a set interval.

10. The system of claim 9 wherein the processor is further operable to:
check the wall time counter against the simulated time counter after all current processor threads are run;
if the wall time counter is greater than the simulated time counter, increment the simulated time counter by one time period; and
if the wall time counter is not greater than the simulated time counter, execute a future processor thread.

11. The system of claim 10 wherein the processor is further operable to:
after executing a future processor thread, compare the wall time counter against the simulated time counter;
execute another future processor thread if the wall time counter is not greater than the simulated time counter;
increment the simulated time counter to a new simulated time period if the wall time counter exceeds the simulated time counter; and
executing all processor threads that must complete during the new simulated time period.

12. The system of claim 8 wherein the wall time counter is maintained within a threshold value of the simulated time counter.

13. The system of claim 12 wherein the wall time counter is suspended when the wall time counter and the simulated time counter differ by more that the threshold.

14. The system of claim 12 wherein the threshold is based on the minimum time that a user would perceive as a delay.

15. The system of claim 8 wherein the processor is further configured to execute a future processor thread that will need to be completed in a future time step closest to the current time step.

16. The system of claim 8 wherein the real time simulation is an avionics simulator.

17. A computer program product comprising a computer useable medium having a computer readable code means embodied in said medium for operating real-time simulation software in a non real-time environment, the computer readable program code comprising:
computer readable program code means for causing the computer to initiate a simulated time counter configured to track simulated time steps;
computer readable program code means for causing the computer to execute all current processor threads;
computer readable program code means for causing the computer to increment the simulated time counter by a next simulated time step; and
computer readable program code means for causing the computer to repeat the execution of all current processor threads for every next simulated time period.

18. The computer program product of claim 17 further comprising:
computer readable program code means for causing the computer to initiate a wall time counter at same time the simulated time counter is initiated, the wall time counter incrementing at a set interval;
computer readable program code means for causing the computer to check the wall time counter against the simulated time counter after all current processor threads are run;
computer readable program code means for causing the computer to incrementing the simulated time counter by one time period, if the wall time counter is greater than the simulated time counter; and
computer readable program code means for causing the computer to execute a future processor thread if the wall time counter is not greater than the simulated time counter.

19. The computer program product of claim 18 further comprising:
computer readable program code means for causing the computer to compare the wall time counter against the simulated time counter after executing a future processor thread;
computer readable program code means for causing the computer to execute another future processor thread if the wall time counter is not greater than the simulated time counter; and
computer readable program code means for causing the computer to increment the simulated time counter if the wall time counter exceeds the simulated time counter; and
computer readable program code means for causing the computer to execute all processor threads that must complete during a new simulated time period.

20. The computer program product of claim 19 further comprising computer readable program code means for causing the computer to maintain the wall time counter within a threshold value of the simulated time counter.

21. A method for scheduling processor threads for a real-time simulation running on a non real-time environment comprising:
executing all current threads within a single simulated time period regardless of actual real time needed for executing;
preventing a total simulation time from exceeding a total reference time; and
preventing the total simulation time from lagging the total reference time.

22. The method of claim 21 where in the step of preventing a total simulation time from exceeding a total reference time further comprising executing future threads to prevent a total simulation time from exceeding a total reference time.

23. The method of claim 21 wherein the step of preventing the total simulation time from lagging the total reference time further comprising maintaining the total simulation time within a threshold of the total reference time.
